(19) United States
(12) Patent Application Publication
(10) Pub. No.: US 2025/0220700 A1
(43) Pub. Date: Jul. 3, 2025

(54) MULTI-LINK DEVICE AND METHOD

(71) Applicant: Sony Group Corporation, Tokyo (JP)

(72) Inventors: Thomas HANDTE, Stuttgart (DE); Kosuke AIO, Stuttgart (DE); Li-hsiang SUN, Stuttgart (DE); Daniel VERENZUELA, Stuttgart (DE); Ken TANAKA, Stuttgart (DE); Dana CIOCHINA-KAR, Stuttgart (DE)

(73) Assignee: Sony Group Corporation, Tokyo (JP)

(21) Appl. No.: 18/848,138

(22) PCT Filed: Mar. 16, 2023
(86) PCT No.: PCT/EP2023/056760

§ 371 Date: Sep. 18, 2024

(30) Foreign Application Priority Data
Mar. 25, 2022 (EP) 22164380.2

(51) Int. Cl. H04W 74/00; H04L 1/00; H04L 25/02; H04W 74/0808

(52) U.S. Cl. CPC H04W 74/002; H04L 1/0003; H04L 25/0212; H04W 74/0808

(57) ABSTRACT

A first multi-link device comprises a first station comprising a transmitter and a receiver and being configured to communicate with a first station of a second multi-link device on a first link; a second station comprising a receiver but no transmitter and being configured to receive control information from another first station of the second multi-link device on a second link different from the first link and/or from another communication device; and circuitry configured to control the first and second stations, wherein the second station is configured to provide the received control information to the circuitry and/or the first station.

### BACKGROUND

### Field of the Disclosure

The present disclosure relates to a first multi-link device and a corresponding method.

### Description of Related Art

Multi-link devices (MLDs) combine multiple stations (STAs), each operating on a specific link, to achieve higher throughput and/or lower latency compared to a single link device. In general, it is desired to have as many links as possible. However, as each link requires an affiliated STA within an MLD, the number of STAs increases with the number of links. This causes a chipset to be more spacious, more expensive, and/or more power hungry in comparison to a single STA chipset which is particularly an issue for consumer non-access point (non-AP) MLD devices.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admitted as prior art against the present disclosure.

### SUMMARY

It is an object to provide a multi-link device requiring less power and having lower complexity compared to a conventional multi-link device, particularly in a scenario where control information is exchanged between multi-link devices. It is a further object to provide a corresponding method as well as a corresponding computer program for implementing the method and a non-transitory computer-readable recording medium for implementing said method.

According to an aspect there is provided a first multi-link device comprising:
a first station comprising a transmitter and a receiver and being configured to communicate with a first station of a second multi-link device on a first link;
a second station comprising a receiver but no transmitter and being configured to receive control information from another first station of the second multi-link device on a second link different from the first link and/or from another communication device; and
circuitry configured to control the first and second stations, wherein the second station is configured to provide the received control information to the circuitry and/or the first station.

According to a further aspect there is provided a multi-link method comprising:
communicating, by a first station comprising a transmitter and a receiver, with a first station of a second multi-link device on a first link;
receiving, by a second station comprising a receiver but no transmitter, control information from another first station of the second multi-link device on a second link different from the first link and/or from another communication device;
controlling, by circuitry, the first and second stations; and
providing the received control information to the circuitry and/or the first station.

According to still further aspects corresponding methods, a computer program comprising program means for causing a computer to carry out the steps of the method disclosed herein, when said computer program is carried out on a computer, as well as a non-transitory computer-readable recording medium that stores therein a computer program product, which, when executed by a processor, causes the method disclosed herein to be performed are provided.

Embodiments are defined in the dependent claims. It shall be understood that the disclosed method, the disclosed computer program and the disclosed computer-readable recording medium have similar and/or identical further embodiments as the claimed devices and as defined in the dependent claims and/or disclosed herein.

One of the aspects of the disclosure is to include a receiving STA (called “second station” or “Rx STA” herein) within a MLD (also called “first multi-link device” or “non-AP MLD” herein), i.e., a STA that can only receive but not transmit. In contrast to a regular STA, a receiving STA can operate at significant lower power and has less complexity. The receiving STA can assist an MLD to receive control information. Further, links to a receiving STA may be setup and cause the regular STA of the same MLD to switch its channel in an advantageous manner using the receiving STA.

In this context it shall be noted that “control information” shall be understood broadly as any kind of information useful for control and/or management, i.e. it may not only include any control data, but also management data. For instance, information carried in control frames and/or management frames, according to e.g. IEEE 802.11, particularly control frames and/or management frames not requiring a response, shall be understood as control information as well.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows a schematic diagram illustrating conventional MLDs that operate on two links.

FIG. 2 shows a schematic diagram of the control plane of an MLD.

FIG. 3 shows schematic diagrams of an embodiment of an AP MLD and of a non-AP MLD according to the present disclosure.

FIG. 4 shows embodiments of a non-AP MLD according to the present disclosure.

FIG. 5 shows a flowchart of a setup phase seen from a non-AP MLD according to the present disclosure.

FIG. 6 shows a schematic diagram of an exemplary MLD setup between an AP MLD and a non-AP MLD according to the present disclosure.

FIG. 7 shows a diagram illustrating a frame exchange between an AP MLD and a non-AP MLD shown in FIG. 6.

FIG. 8 shows a diagram illustrating acknowledgement timeout under the assumption of a non-zero reception status propagation delay.

FIG. 9 shows another diagram illustrating acknowledgement timeout under the assumption of a non-zero reception status propagation delay.

FIG. 10 shows a diagram illustrating another option to minimize the time until acknowledgement response.

FIG. 11 shows a diagram illustrating the case in which an AP STA waits for the reception status to be delivered.

FIG. 12 shows a diagram illustrating the case in which AP STA continues to access a link although a reception status of an initial transmission has not yet been received.

FIG. 13 shows a schematic diagram of another exemplary MLD setup between an AP MLD and a non-AP MLD according to the present disclosure.

FIG. 14 shows a diagram illustrating how the data receiving Rx STA may contribute to low-latency data delivery.

FIG. 15 shows a schematic diagram of an exemplary MLD setup, in which the flow of control information is illustrated.

FIG. 16 shows a diagram illustrating parameters extraction from a received legacy header of a PPDU.

FIG. 17 shows link state information detection by energy and/or preamble detection of the observed channel.

FIG. 18 shows a diagram illustrating link switch on the basis of Rx STA link state information.

FIG. 19 shows diagrams illustrating enhanced single radio operation with an Rx STA.

### DETAILED DESCRIPTION OF THE EMBODIMENTS

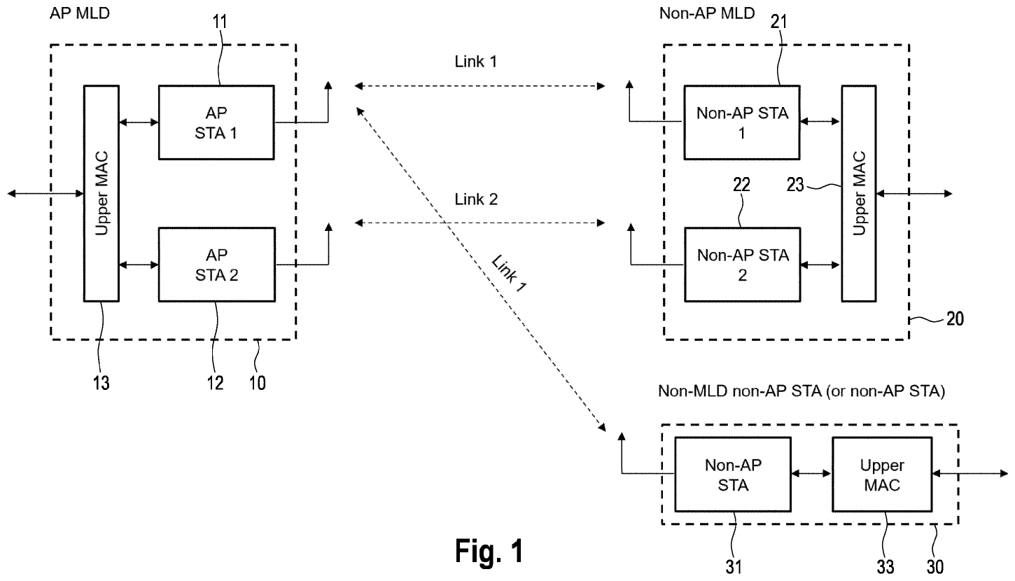

Referring now to the drawings, wherein like reference numerals designate identical or corresponding parts throughout the several views, FIG. 1 shows a schematic diagram illustrating two multi-link devices (MLD) 10, 20 that operate on two links (multi-link operation, MLO). A MLD comprises multiple affiliated STAs (stations), either AP STAs (access point STA) 11, 12 or non-AP STA 21, 22. Each STA comprises a transmitter and a receiver PHY (physical layer) to enable a bidirectional data exchange in time division duplex (TDD) as well as a lower media access control (MAC) sublayer. Within an MLD, the upper MAC sublayer 13, 23 converges the data flows of both links. Typically, each STA operates on a different channel and thereby creates a bidirectional link between each AP STA 11, 12 and non-AP STA 21, 22 as shown in FIG. 1. Communication across different links can occur simultaneously or not depending on the capabilities of both the AP MLD 10 and the non-AP MLD 20. FIG. 1 also shows a non-MLD non-AP STA 30 that may connect to an AP MLD 10 via a single link via AP STA 11. The non-AP STA 31 and upper MAC layer 33 for non-MLD 30 are often combined and called non-AP STA.

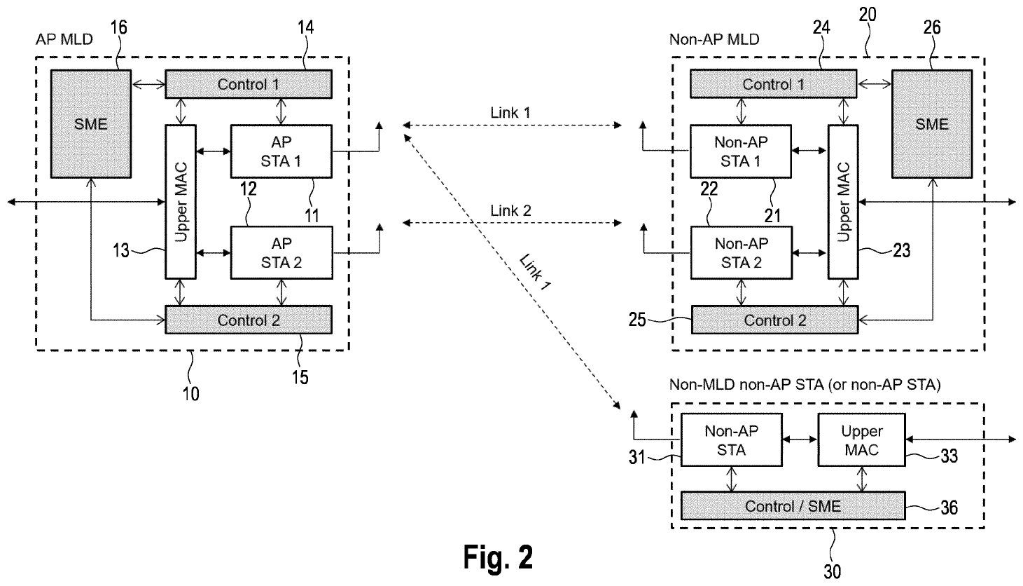

Within an MLD, each affiliated STA often operates independently in terms of PHY and lower MAC processing. However, the upper MAC processing is shared among both STAs. FIG. 2 shows a schematic diagram of the control plane of an MLD. Each STA 11, 12, 21, 22, 31 features a control unit 14, 15, 24, 25, 36 that controls the STA, lower, and upper MAC sublayer 13, 23, 33. Moreover, the MLD features a SME (station management entity) 16, 26, 36 (or central control unit) that controls the control units of every affiliated STA. The SME performs its control task such that the upper MAC sublayer performs adequate operations. The SME can also perform other tasks that are not related to PHY and MAC but higher layers.

In general, it is desired to have as many links as possible to reduce channel access delay i.e., the link that gets idle first can be used for data exchange, enhance throughput, i.e., the throughput of each link accumulates, and enhance availability, i.e., with multiple links, the likelihood that it is idle increases. However, as each link requires an affiliated STA within an MLD, the number of STAs increases with the number of links. This causes a chipset to be more spacious, more expensive and/or more power hungry in comparison to a single STA chipset, which is particularly an issue for consumer non-AP MLD devices.

The reason for these issues is that each STA is a regular STA and supports all features such as transmission and reception of various frames at various rates, bandwidths and streams. These features are always supported regardless if currently used or not. These features can be temporarily disabled by power save technologies; however, they are still present and deployed, and disabled features have no functionality while in power save mode.

Furthermore, a link switch, i.e. a STA changing from a first link to a second link, creates overhead and requires a STA to observe the wireless medium for a certain time span before it may access the channel (also called minimum observation period herein). Furthermore, if the STA is an AP STA, it needs to inform its associated STAs about the link switch in advance or disassociate these STAs. Therefore, a link switch is not an option to reduce channel access delay. Further, the link state (“busy” or “idle”) of the link a STA plans to switch to is not clear before the switching operation. Therefore, a STA may switch to a second link with more unfavorable conditions than the first link.

According to the present disclosure a Rx STA is provided as part of an MLD. A Rx STA is a receive-only STA, i.e., it cannot transmit but just receive. In order to save further power, the reception capabilities may optionally be limited in the sense that the supported PHY configurations and/or MAC frames are very sparse. A Rx STA is generally a low-complexity, low-power STA. Hence, the deployment of a Rx STA has less implementation burden than a conventional STA. In contrast, the gains achieved by Rx STA are lower compared to a conventional STA but still significant.

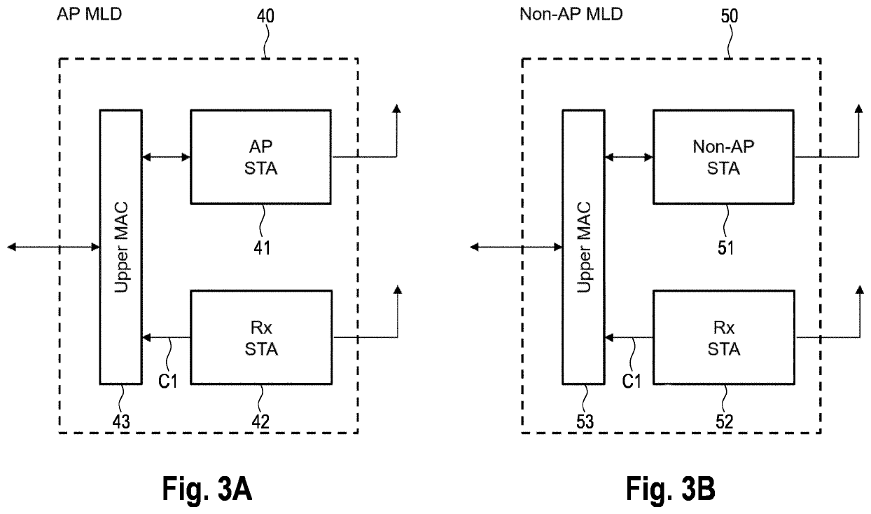

FIG. 3A shows a schematic diagram of an embodiment of an AP MLD 40 and FIG. 3B shows a schematic diagram of an embodiment of a non-AP MLD 50 according to the present disclosure. Each of the MLDs 40 and 50 (herein also called “first multi-link device” or “first MLD”) comprises one or more (regular) STAs 41, 51 (having transmission and reception functionality; herein also called “first STA”) and at least one (affiliated) Rx STA 42, 52 (having only reception functionality; herein also called “second STA”). As shown in FIGS. 1 and 2, upper MAC sublayers 43, 53 may be provided as well. A Rx STA cannot exist alone, i.e., not as part of an MLD, because the missing transmission functionality is essential to communicate even if data or other information is only received as will be explained below. A Rx STA may be part of an AP MLD or non-AP MLD, wherein Rx STAs may be more beneficial at non-AP MLDs in which power save and cost are most important. A Rx STA can generally provide control information and/or data to the MLD. Therefore, the connection C1 shown in FIG. 3 illustrating data flow may be present or not; it is particularly present only when the Rx STA provides data to the MLD.

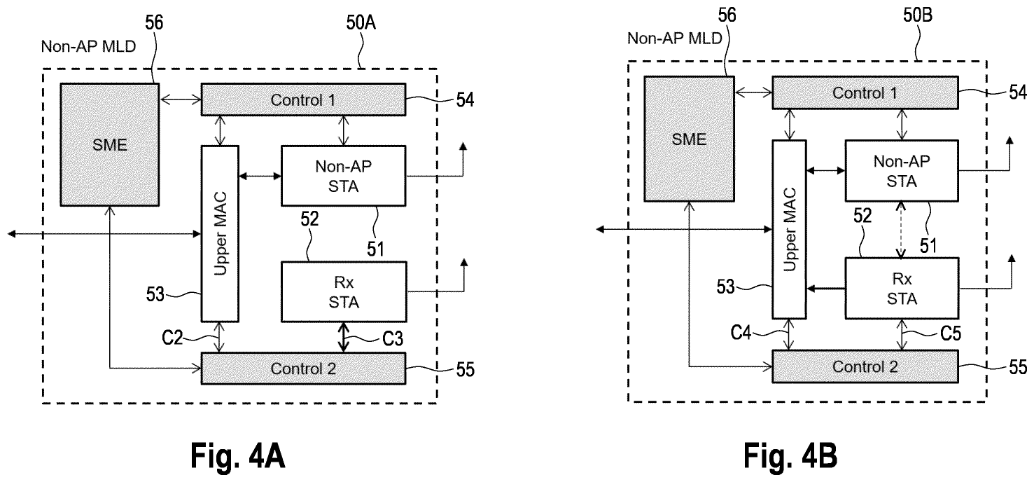

FIG. 4 shows embodiments of a non-AP MLD 50A, 50B in more detail. As shown in FIG. 2, control units 54, 55 and an SME 56 are provided as well (one or more of the elements 53-56 herein also called “circuitry”). It shall be noted that in some embodiments, particularly the signal processing block “upper MAC layer” labelled as 43, 53, 63 in the figures may be considered as being part of the circuitry mentioned herein.

FIG. 4A shows the case in which the Rx STA 52 provides control information to the MLD via connection C3. The purpose of connection C3 in direction to the Rx STA 52 is mainly for configuration of the Rx STA's receiver (e.g. for configuration of a channel (i.e. link) to observe) and C3's main purpose in direction to the control unit 55 is to supply the SME 56 and/or the control unit 54 and/or the upper MAC sublayer 53 with control information. Connection C2 may be present or not, in which case the upper MAC sublayer 53 is controlled via the SME 56 and the control unit 54.

FIG. 4B shows the case in which the Rx STA 52 provides data to the MLD. The control information exchanged via connection C5 is provided for configuration of the Rx STA's receiver (direction to Rx STA 52) and for reception notification (direction from Rx STA 52). As for the connection C2, the connection C4 may be present or not. Often, the connection C4 may be needed to control the upper MAC sublayer 53 to insert the received data into the data stream. As will be explained below, the control link from the Rx STA 52 to a non-AP STA 51 and vice versa e.g., via the upper MAC sublayer 53 or the SME 62 may be important for operation. Even a direct link (indicated as dotted line in FIG. 4B) may be provided. One (not necessarily the only) purpose of the control link from Rx STA 52 to non-AP STA 51, regardless if routed via upper MAC sublayer/SME or directly, is to deliver acknowledgements to received data units by Rx STA 52 and/or relay data or control information to the AP MLD (second MLD) as described in more detail below.

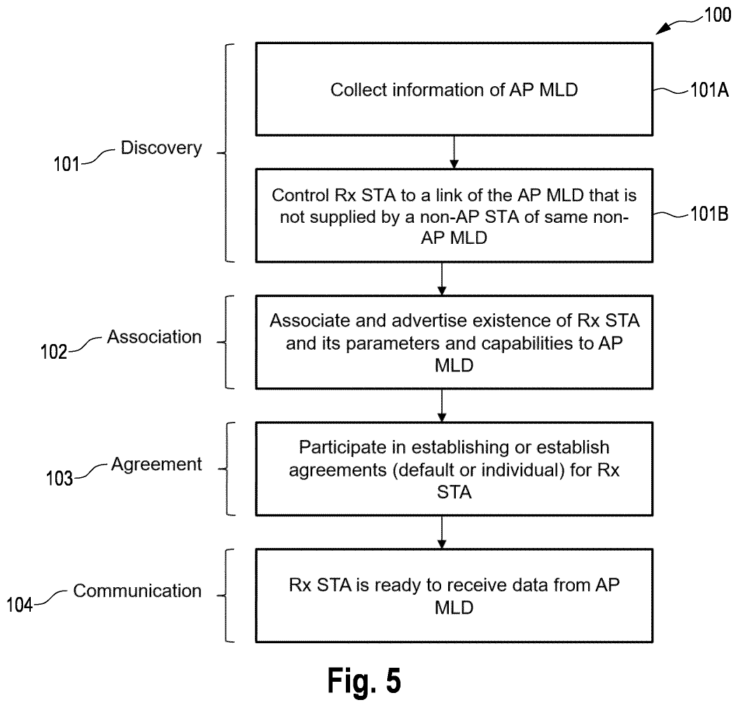

In the following, the case in which the Rx STA provides received data to the MLD, as provided according to a first aspect of the present disclosure, shall be discussed. FIG. 5 shows a flowchart of a setup phase 100 seen from a non-AP MLD for the case in which a Rx STA should receive data. The setup phase 100 may have four sub-phases: discovery phase 101, association phase 102, agreement phase 103 and communication phase 104. For the case in which a Rx STA should receive control information only (which will be discussed later), some cases require the first two sub-phases (discovery and association) of the setup phase 100 to be executed. Sometimes also an agreement 103 may be used to, e.g., agree on encryption parameters or observed links for EMLSR operation.

During the discovery phase 101, any affiliated non-AP STA of a non-AP MLD may collect information about an AP MLD's configuration (step 101A). The non-AP MLD may control (step 101B) an affiliated Rx STA such that it can receive data from a link provided by the AP MLD that is not supplied by an affiliated non-AP STA of the same non-AP MLD.

In the subsequent association phase 102, a non-AP STA affiliated with a non-AP MLD advertises the existence of a Rx STA and, optionally, its parameters and/or capabilities such as channel, bandwidth, supported PHY and MAC configuration. Depending on implementation of a Rx STA, it may change its observing channel frequently. In this case, a non-AP STA shall include a channel schedule, according to which the Rx STA affiliated to same non-AP MLD plans to change its observing channel.

After the association phase 102, in the agreement phase 103 a non-AP STA affiliated with a non-AP MLD may participate in establishing or establish agreements with its peer AP MLD. These agreements may particularly include one or more of:
A BlockAck (BAck) agreement, which configures the use of a BAck such as score-board size. (The BAck agreement for the Rx STA is initiated by the AP MLD as Rx STA receives in downlink).
A 4-way handshake to exchange encryption parameters to enable secure communication among the non-AP and AP MLD. The 4-way handshake for the Rx STA is initiated by the AP MLD as Rx STA receives in downlink.
A TID (traffic identifier)-to-link mapping request/response, which may be initiated by AP MLD or non-AP MLD.

By default, all agreements hold also for the link towards a Rx STA. Optionally, different parameters may apply to a link towards a Rx STA in which case a non-AP STA affiliated to same non-AP MLD establishes separate agreements with its peer AP MLD for this link.

Since the setup phase 100 requires data transmission (e.g. for association), a Rx STA cannot exist alone but requires at least one regular STA, and both are interconnected within an MLD.

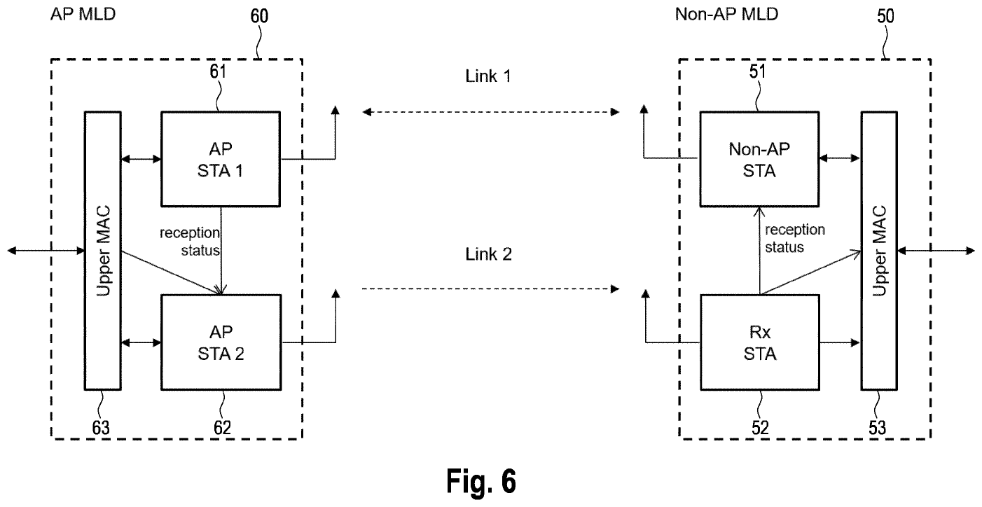

FIG. 6 shows a schematic diagram of an exemplary MLD setup between an AP MLD 60 (herein also called “second multi-link device” or “second MLD”) and a non-AP MLD 50 (“first MLD”). The AP MLD comprises two AP STAs 61, 62 (i.e. first stations having transmission and reception functionality) and an upper MAC sublayer 63. Two links are established, link 1 between the AP STA 61 and the non-AP STA 51 and link 2 from the AP STA 62 to the Rx STA 52, the STAs 51, 52 both affiliated with same non-AP MLD 50.

Since a Rx STA 52 comprises a receiver only, it cannot transmit a Ack or BAck to the transmitter in response to one or more data units. Therefore, the data unit transmitted to a Rx STA 52 shall either not request an acknowledgement or cause an acknowledgement (e.g. Back) to be transmitted via another link to an AP STA 61 of the same MLD 60 to which the transmitting AP STA 62 is affiliated to. Such an acknowledgement can contain not only acknowledgements of the data units transmitted to the Rx STA 52 but also acknowledgements from data units transmitted to one or more non-AP STAs 51 affiliated to the same non-AP MLD 50.

An AP STA 62 transmitting a data unit of a certain TID shall only transmit to a Rx STA 52, if previously an agreement on acknowledgement (e.g. a BAck agreement) has been setup for that TID and that TID is mapped to the receive-only link and to at least one link supplied by a non-AP STA 51 affiliated to same non-AP MLD 50 as the Rx STA 52. This includes that the sequence numbers to identify data units from same TID originate from same sequence number space for both the link of the Rx STA 52 as well as one or more link to non-AP STA 51. An acknowledgement to data units transmitted to the Rx STA 52 may only be delivered via a link which has the TID of said data units enabled.

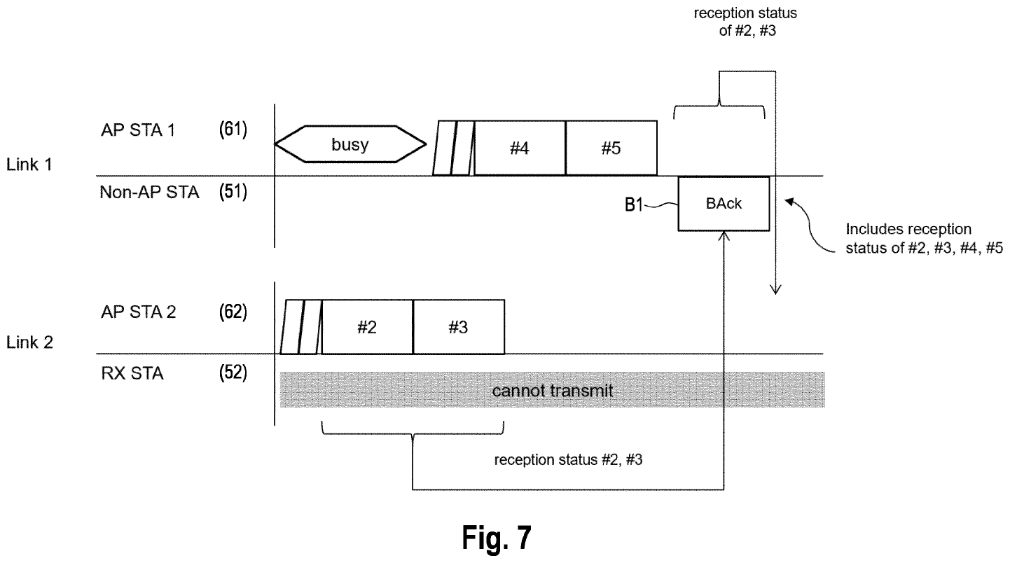

FIG. 7 shows a diagram illustrating a frame exchange between an AP MLD 60 and non-AP MLD 50 shown in FIG. 6. In this example, it is assumed that the AP STA 2 (62) transmits data units #2 and #3 to Rx STA 52 and request for both an Ack. After reception of both data units, the reception state is forwarded to the non-AP STA 1 (51) for inclusion in the next BAck transmitted to the AP MLD 60. In this example, it is assumed that the non-AP STA 1 (51) transmits the next BAck B1 in response to reception of data units #4 and #5. The non-AP STA 1 (51) may also provide BAck status based on a BAck request by AP STA 1 (61). Thus, the BAck B1 includes reception status of data unit #2 to #5. Hereby, it is assumed that data units #2 to #5 originated from the same TID. However, they may originate from different TIDs too, in which case the BAck B1 holds reception state of multiple TIDs. At the AP MLD 60, the reception status of data units #2 and #3 is forwarded to AP STA 2 (62) for further consideration e.g., retransmission. The last step is optionally since the AP MLD 60 may decide to retransmit data units #2 and #3 via link 1 for example.

The reception status of Rx STA 52 may take a while to propagate to AP STA 62 that transmitted the data units. For this reason, the following approach may be applied: A STA transmitting one or more data units requiring a response to a Rx STA 52 shall assume that a data unit did not arrive at the Rx STA 52 not earlier than a first BAck arrived from the same MLD 50 to which the Rx STA 52 is affiliated to, which indicates that the data unit did not arrive, or no such information is present. The reception status for data units that are directed towards a Rx STA 52 shall be included into the next BAck B1 transmitted to the MLD 50 to which the peer STA 51 of the Rx STA 52 is affiliated to.

In this context it shall be noted that the terms “first BAck” or “next BAck” shall be interpreted as the first or next acknowledgement (e.g. Back) after the PPDU holding the data units ended and may include a reception status propagation delay to account for processing delay. If present, the reception status propagation delay is indicated during setup phase. Further, it shall be noted that a Back may be considered as a single acknowledgement that includes multiple acknowledgements.

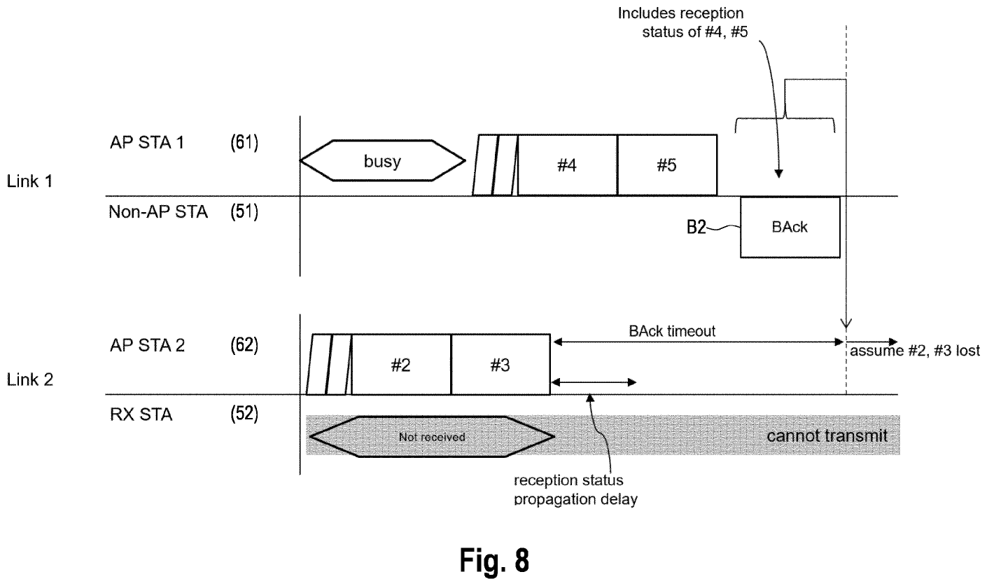

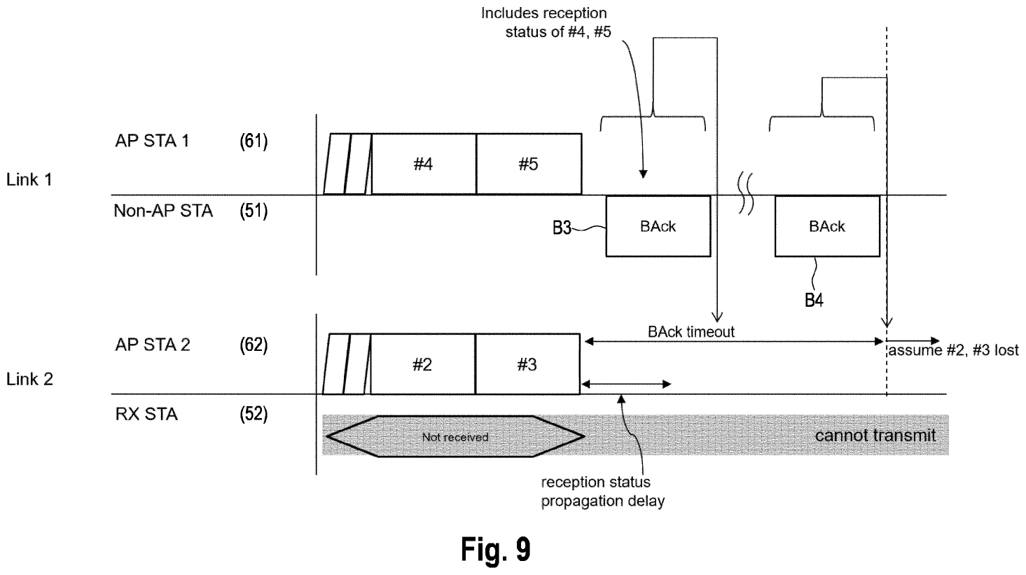

FIGS. 8 and 9 show diagrams illustrating the BAck timeout under the assumption of a non-zero reception status propagation delay. In FIG. 8, the first BAck B2 after the PPDU holding data units #2 and #3 is well after the reception status propagation delay for which reason the first BAck B2 could contain the reception status of these data units. In FIG. 9, the first BAck B3 after the PPDU holding data units #2 and #3 starts to be transmitted before the reception status propagation delay has ended. Thus, the reception status of data units #2 and #3 could be included in the second BAck B4 sent by the affiliated non-AP STA 51.

The AP MLD 50 may request a BAck to solicit a BAck response to minimize the BAck timeout. Alternatively, the non-AP STA 60 may transmit the BAck unsolicited i.e., without request. Thus, after the Rx STA 52 received data units, the non-AP STA 51 may contend for channel access to transmit a BAck.

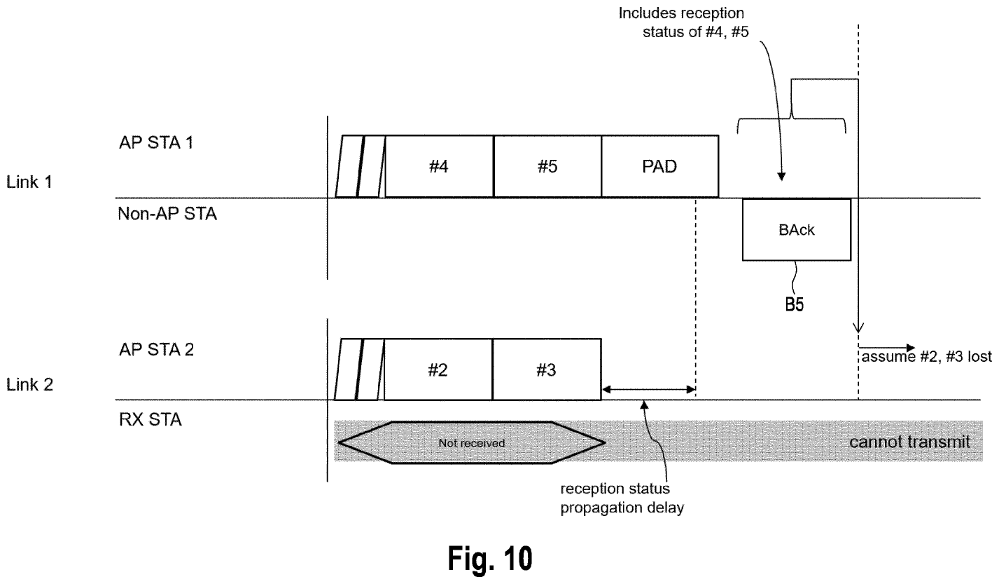

FIG. 10 shows a diagram illustrating another option to minimize the time until a BAck response requires the reception status propagation delay to be known at AP STA 61. In such a case, AP STA 61 may include padding (“PAD”) after the last data unit or add further data units (e.g. data units of other TIDs) to the PPDU. By prolonging the PPDU beyond the reception status propagation delay, the BAck B5, which is transmitted as a response to the prolonged PPDU, could already include the reception status of the data units received by Rx STA 52.

Any STA operating in unlicensed bands should perform listen before talk (LBT), which is parameterized by contention window (CW) value. When a STA receives a data unit to be transmitted, it draws a random backoff counter in the interval [0, CW]. CW is selected depending on the status of the previous transmission: If the previous transmission was successful, i.e., a response to a transmission has been received, CW=CWₘᵢₙ holds, otherwise CW is incremented e.g. by CW_{new}=2·CW_{old}+1 for each successive non-received response to a transmission, i.e., CW is approximately doubled. The CW value is often specific to a certain access category (AC) queue to differentiate different priorities of data units (e.g. voice, video, best effort and background). CW values are managed (e.g., increased, initialized) per AC.

The AP STA of an AP MLD, transmitting a data unit that requires a response frame (e.g. BAck) and that is transmitted on a link towards a Rx STA, shall either not transmit before the AP MLD received a related response via another link from a non-AP STA of same non-AP MLD to which the Rx STA is affiliated to, or increment its CW for an upcoming transmission unless the AP MLD received a response via another link from a non-AP STA affiliated to the same MLD than the Rx STA in which case CW=CWₘᵢₙ holds.

An exemplary implementation provides that the CW value addressed here is only valid for transmissions towards Rx STAs and may be further differentiated per AC. This is advantageous because the response frame may be delayed due to the link carrying the BAck being busy. In case regular CW was used, the traffic to other regular STAs would be penalized unnecessarily.

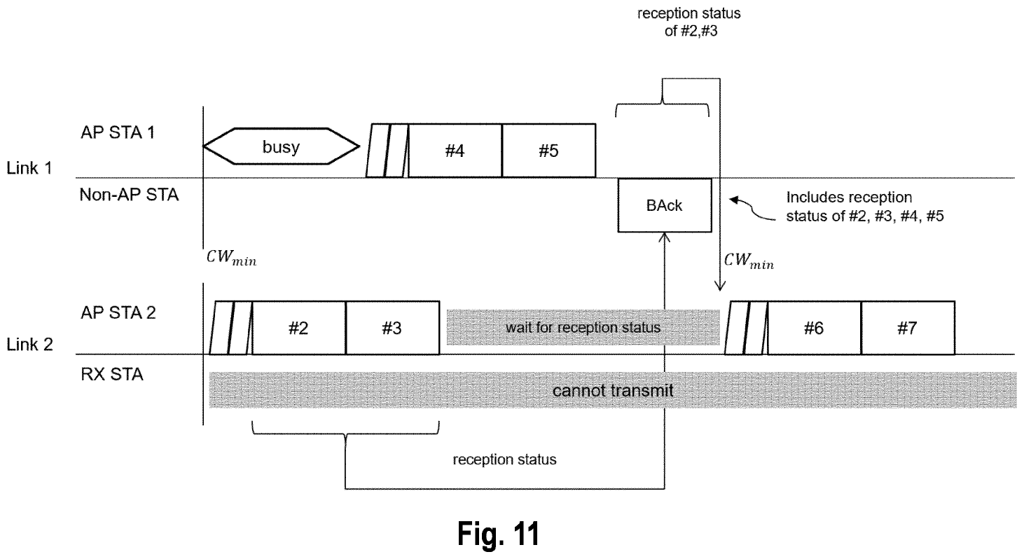

FIG. 11 shows a diagram illustrating the case in which AP STA 62 waits for the reception status to be delivered via link 1 before it resumes contention after an initial transmission. The random backoff interval is always parameterized with CWₘᵢₙ. According to the implementation option the “wait for reception status” phase may not hold for transmissions to regular STAs and/or to Rx STAs using a different AC.

If the AP STA features a FIFO ordered transmit queue, there are two options to implement the “wait for reception status” phase: According to a first option, the AP STA checks the destination of the first data unit in its queue. If the destination is the Rx STA, a response is outstanding, and BAck timeout did not yet pass, it does not start backoff procedure, otherwise it does. According to a second option the AP STA starts backoff first but checks destination STA of the first data unit in the queue. If the destination is the Rx STA and a response is outstanding, it stops backoff procedure and continues once a response has been received or BAck timeout happened.

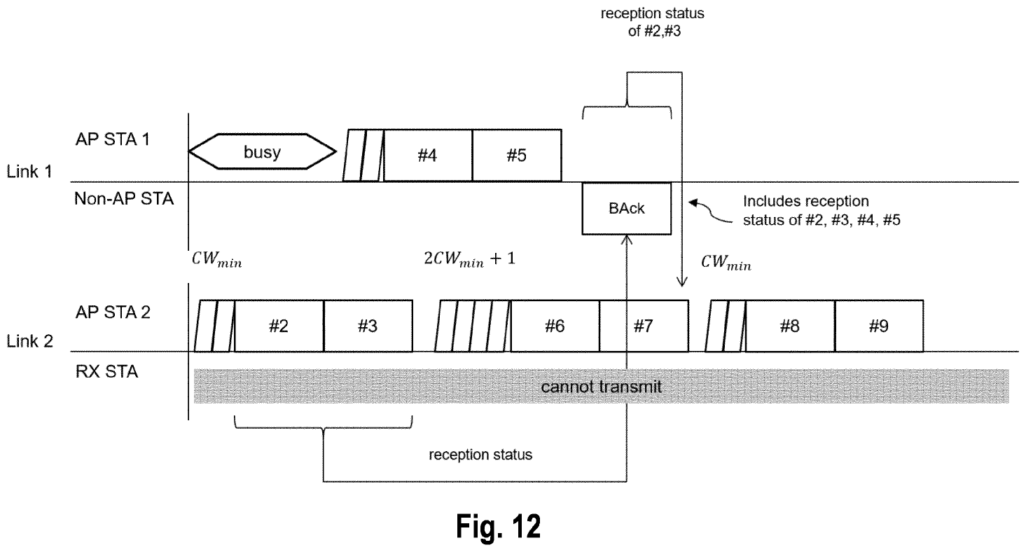

FIG. 12 shows a diagram illustrating the case in which AP STA 2 (62) continues to access link 2 although a reception status of an initial transmission has not yet been received via link 1. As illustrated, the random backoff interval of the second transmission is parameterized with 2CWₘᵢₙ+1, because the reception status of the initial transmission is yet unknown to AP STA 62. Once the reception status arrives at an affiliated AP STA 61 that already started backoff for an upcoming transmission, it may either shorten backoff, or reinitialize backoff, or continue using the previous backoff.

The BAck transmitted by non-AP STA 51 does not contain reception status of data units #6 and #7 because these data units have not yet been received, when the BAck is transmitted. Therefore, the third transmission by AP STA 62 is an interesting case because at the point in time of initiation, the reception status of data units #2 and #3 is clear, whereas for data units #6 and #7 it is unclear. In such a case three options for initialization of the CW value exist:
initialize with CWmin (as shown in FIG. 12);
initialize with previous CW i.e., keep CW as is (this would be 2CWₘᵢₙ+1); and
initialize with increased CW (this would be 4CWₘᵢₙ+3).

The last option corresponds to a failed transmission or no reception status available although partial reception status is available. Thus, the first and second options are more viable. According to the implementation option the CW increase may not hold for transmissions to regular STAs and/or to Rx STAs using a different AC.

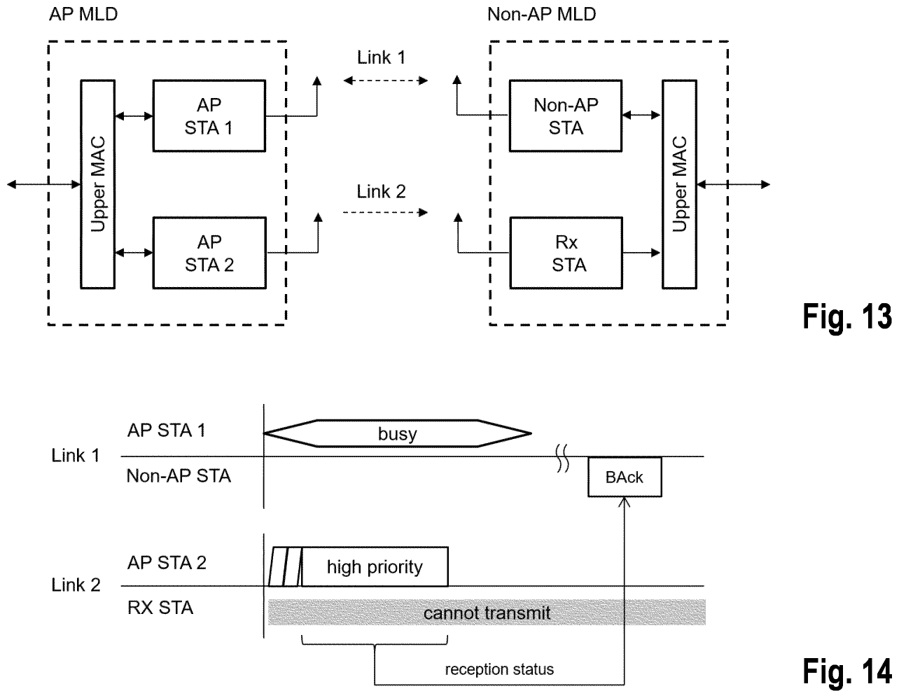

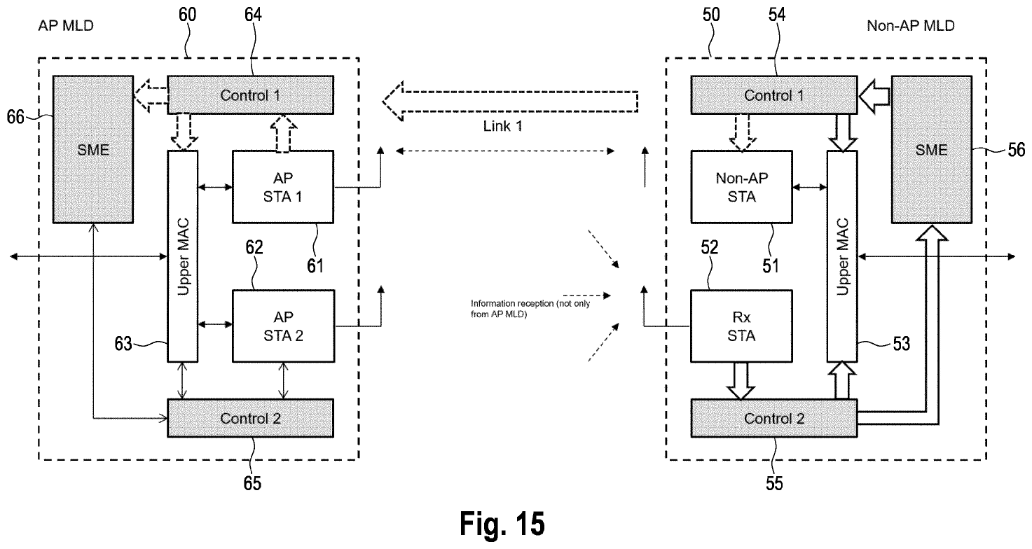

FIG. 13 shows a schematic diagram of another exemplary MLD setup between an AP MLD 60 and a non-AP MLD 50. FIG. 14 shows a diagram illustrating how the data receiving Rx STA 52 may contribute to low-latency data delivery. Link 1 is detected as busy for a long time. Since the Rx STA 52 can receive data on link 2, which is assumed to be idle, the AP MLD 60 can readily transmit the latency-sensitive data units to the non-AP MLD 50. The acknowledgement of these data units will arrive at a later point in time via link 1. However, if correctly received, the data units can be readily processed by the application layer at the non-AP MLD 50, although the reception status is unknown at the AP MLD 60.

In the following, the case in which the Rx STA provides control information to the non-AP MLD, as provided according to a second aspect of the present disclosure, shall be discussed. In the previous case according to the first aspect, the reception status of the data units received by the Rx STA can be seen as control information that is forwarded from the Rx STA to its non-AP MLD. In contrast, according to the second aspect control information that is obtained by the Rx STA by listening to the medium and that is not related to data frames directed towards the Rx STA is used. Such control information is often included in control frames or management frames (directed towards the Rx STA or not) or any PPDU directed towards other STAs. In this variant, no data frames are directed to the Rx STA as unicast, but control frames (or management frames) may be directed to the Rx STA. As mentioned above, for this case the first two or even three phases of FIG. 5 (discovery and association) may be executed.

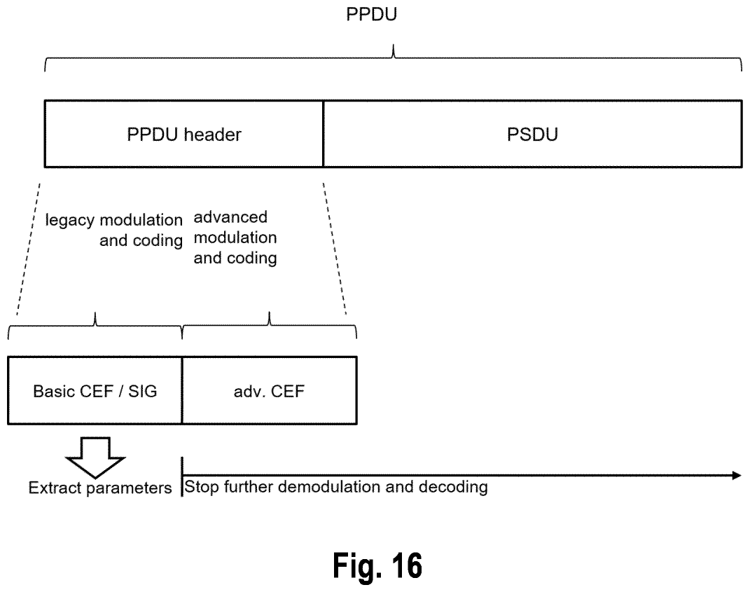

FIG. 15 shows a schematic diagram of the exemplary MLD setup between the AP MLD 60 (as e.g. shown in FIG. 6, with additional elements 64-66 as provided in the AP MLD 10 shown in FIG. 2) and the non-AP MLD 50 (as e.g. shown in FIGS. 4A and 4B), in which the flow of control information is illustrated. There are two subvariants: In the first subvariant, the control information retrieved by the Rx STA 52 is used within the same MLD. The main control flow for this case is depicted with solid thick arrows. In the second subvariant, the control information retrieved by the Rx STA 52 is forwarded by the MLD via the non-AP STA 51 and an AP STA 61 to the AP MLD 60. This control information can be used in different contexts within the AP MLD 60, e.g., channel busy information or OBSS information can trigger the AP MLD 60 to switch its links to different channels. The information flow of the second subvariant includes the solid and the dashed thick arrows. While the control information within the non-AP MLD 50 can be forwarded with minor delay the forwarding to the AP MLD 60 may take time due to channel access delay. Therefore, average values of the observed parameters are suitable in the latter case, whereas also instantaneous values may be forwarded in the former case.

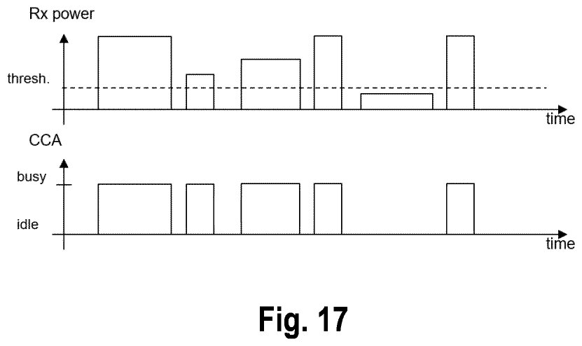

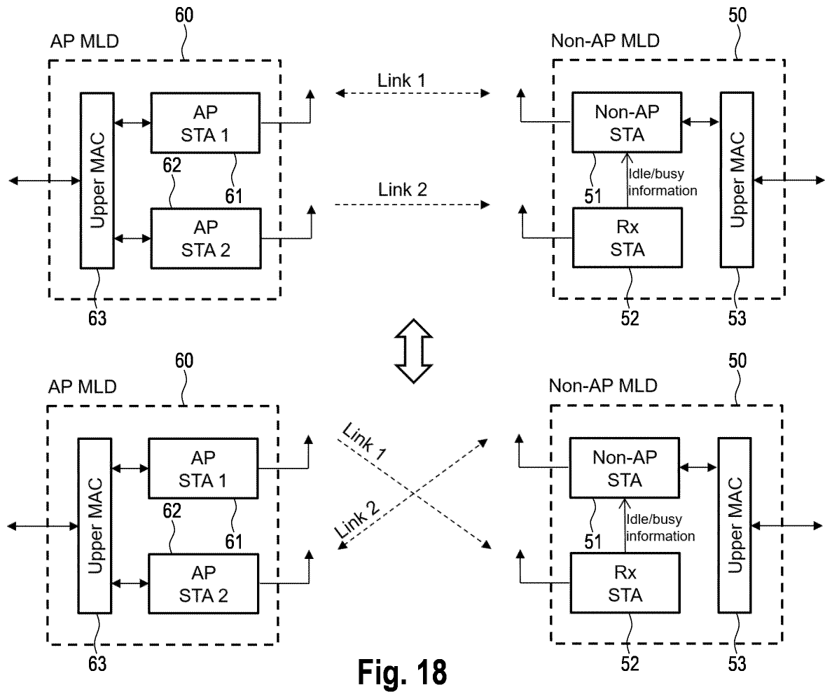

The control information that can be obtained by the Rx STA 52 and that is provided to at least the non-AP MLD 50 to which it is affiliated to may include:
a) Link state information or link information in terms of one or more of length of the currently received PPDU, bandwidth of the received PPDU, TXOP duration or NAV, received power, BSS identifier of the currently received PPDU (BSS color) and restricted channel (puncturing) information of the currently received PPDU. These parameters can be extracted from a received legacy header of a PPDU as shown in FIG. 16 or from received control frames such as RTS or CTS.
b) Link state information or link information in terms of current busy/idle state (CCA—carrier clear assessment) of the observed channel. This indication may be derived by energy and/or (WLAN) preamble detection of the observed channel as shown in FIG. 17. There may be a minor skew between received power and CCA.
c) Channel state information in terms of an impulse response and/or transfer function between a transmitter and the Rx STA determined from a received PPDU (often null data packet, NDP).
d) Operation advice information in terms of reception of control frames to configure or reconfigure the non-AP MLD operation.

The information listed above can be used for various purposes. It is assumed that the non-AP MLD 50 would like to transmit data to the AP MLD 60. The control information of the Rx STA 52 can assist the non-AP STA 51 in this task. In particular, the Rx STA 52 may perform one or more of the following operations:
i. Control the non-AP STAs to be steered to idle links. Such a steering may be temporary, i.e., to accomplish one or more frame exchanges with the peer MLD or quasi permanently, i.e. for a longer time period. Information a) and/or b) may be helpful for the non-AP MLD to decide.
ii. Perform the CW count down for a non-AP STA to transmit after CW count down. Thereby, the Rx STA observes CCA (information b)), while the non-AP STA is switching to the link observed by Rx STA which may take some switching delay. For CCA information to be correctly obtained, the bandwidth of the Rx STA and non-AP STA must be either the same or cover at least the primary (e.g. 20 MHZ) channel of the link on which the CW count down is performed.
iii. Enable a non-AP STA to switch its link without or with reduced medium sync delay timer. In multi-link (ML) operation, when a non-AP STA would like to use a different link, which is has not observed before or which it could not observe, it should respect a timeout before transmitting anything. This is for the non-AP STA to gather information about link medium such as NAV. In case the medium has been continuously observed by an Rx STA, the information gathering is obsolete and therefore a non-AP STA may transmit immediately, i.e., ignore medium sync delay, or transmit after a shorter observation period, i.e. shorter medium sync delay. Information a) and/or b) may be used for this operation. If the AP MLD initiates the link switch by a trigger frame (e.g. MU-RTS trigger frame), the trigger frame shall be configured such that the non-AP MLD should perform carrier sense before accessing the medium.

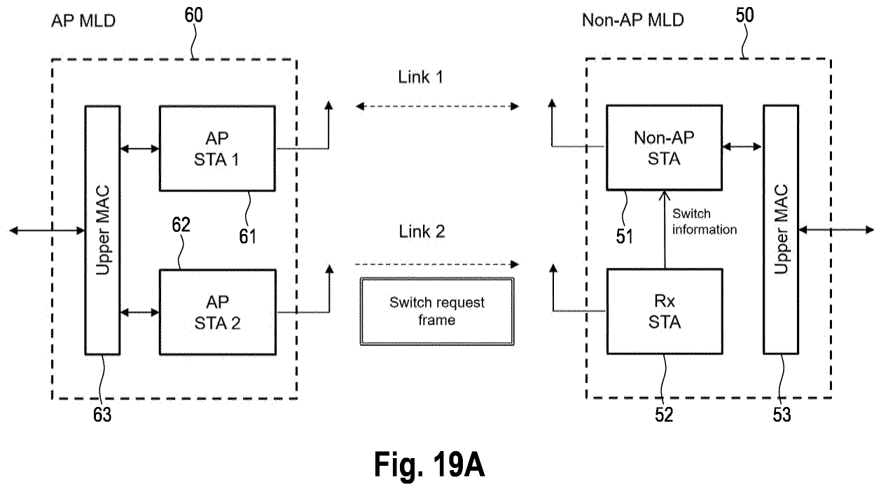

The previous three application examples are illustrated in FIG. 18 showing a diagram illustrating link switch on the basis of Rx STA link state information. It is hereby assumed that the non-AP MLD 50 would like to transmit data, but link 1 is busy. Based on link state information obtained by the Rx STA 52, the non-AP STA 51 of the non-AP MLD 50 may switch to link 2 to perform its frame exchange with the AP MLD 60. If the Rx STA 52 can perform CW count down, the link switch delay of non-AP STA 51 can be already used for CW count down; hence, the frame exchange may start earlier. While the non-AP STA 51 transmits on link 2, the Rx STA 52 may observe link 1 to avoid or reduce medium sync delay timer.

Since AP MLD 60 may start downlink data transmission via link 1 where it expects a non-AP STA 51 and not a Rx STA 52 to receive or to respond, the non-AP MLD 51 should inform the AP MLD 60 immediately about its link switch via a link switch announcement. This may be accomplished before the actual link switch if the original link can be accessed and is served by a non-AP STA 51 or after the actual link switch if the original link cannot be accessed or is observed by a Rx STA 52. In the latter case the non-AP STA 51 may include a link switch announcement as first data unit or in the first data unit that is transmitted after a link switch. The link switch announcement may include a time span that indicates the length of the link switch and after which the link switch is inverted.

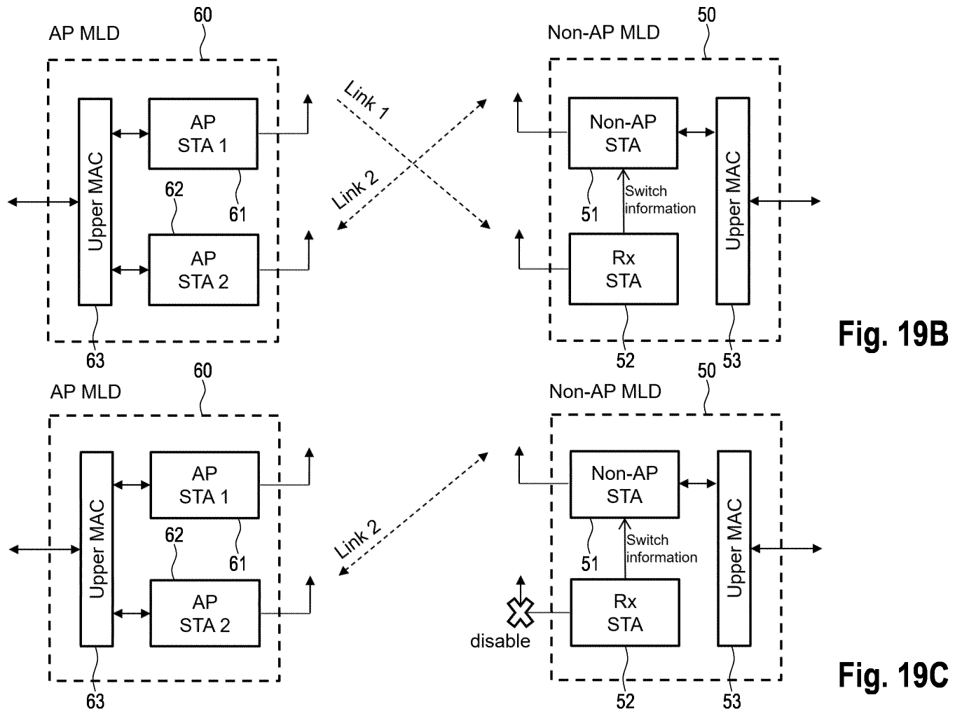

The control information obtained by the Rx STA 52 may also assist in transmission of downlink traffic. Thus, it is assumed that the AP MLD 60 would like to transmit data to the non-AP MLD 50. The Rx STA 52 may perform one or more of the following operations:
i. Provide a measured impulse response or transfer function of the channel observed by the Rx STA. This channel state information or beamforming information derived thereof may subsequently be fed back to the peer MLD via a non-AP STA. The peer STA of the Rx STA may then apply beamforming to the link to Rx STA. This operation may be applied if the Rx STA is receiving data units too. Information c) mentioned above as well as information forwarding as shown in FIG. 15 (dashed arrows) may be used for this operation.
ii. Control the resources of an enhanced single radio (EMLSR) non-AP STA. In EMLSR control frames received from the AP MLD indicate to which link the non-AP STA should switch or focus its resources to subsequently perform a data exchange. For the reception of such a frame, the EMLSR operation foresees to split the receiving resources of the non-AP STA, which is not required when a Rx STA is present. FIG. 19 shows diagrams illustrating EMLSR operation with an Rx STA. FIG. 19A shows the initial state before the link switch and FIGS. 19B and 19C show two options for the link switch.

As shown in FIG. 19A, one link is observed by the non-AP STA 51 whereas the other is observed by the Rx STA 52. When the Rx STA 52 receives an EMLSR control frame (switch request frame), it causes the non-AP STA 51 to switch its link to the one observed by the Rx STA 52. The Rx STA 52 may then either switch to the formerly observed link of the non-AP STA 51 to obtain link state information to avoid a medium sync delay for the non-AP STA when switching back (FIG. 19B) or the Rx STA 52 may disable its radio (FIG. 19C). Information d) mentioned above may be used for this operation. Since the link switching is different from baseline EMLSR, the switching delay for this operation may be different, too. Furthermore, when in setup of FIG. 19 a switch request frame is transmitted on link 1, the switching delay is zero as non-AP STA 51 is already tuned to link 1. For the same reason, a switching request is actually not needed on link 1.

For the AP MLD 60 to be aware of the Rx STA 52 or EMLSR operation with a Rx STA 52, at least the first two phases shown in FIG. 5 (discovery and association) should be executed in a previous setup phase.

In summary, according to the present disclosure one or more receiving STAs may be included within a MLD, i.e., one or more STAs that can only receive but not transmit. In contrast to a regular STA, a receiving STA can operate at significant lower power and has less complexity. A receiving STA can assist an MLD to receive data and/or control information. Further, the present disclosure describes how links to a receive-only STA can be setup, how response frames such as acknowledgements may be conveyed, and how listen-before-talk mechanism may be augmented. Furthermore, it is elaborated how the control information can be obtained by a receiving STA and how it can be applied in various contexts.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriate circuits or circuitry. A circuit is a structural assemblage of electronic components including conventional circuit elements, integrated circuits including application specific integrated circuits, standard integrated circuits, application specific standard products, and field programmable gate arrays. Further, a circuit includes central processing units, graphics processing units, and microprocessors which are programmed or configured according to software code. A circuit does not include pure software, although a circuit includes the above-described hardware executing software. A circuit or circuitry may be implemented by a single device or unit or multiple devices or units, or chipset(s), or processor(s).

It follows a list of further embodiments of the disclosed subject matter:

1. First multi-link device comprising:
a first station comprising a transmitter and a receiver and being configured to communicate with a first station of a second multi-link device on a first link;
a second station comprising a receiver but no transmitter and being configured to receive control information from another first station of the second multi-link device on a second link different from the first link and/or from another communication device; and
circuitry configured to control the first and second stations, wherein the second station is configured to provide the received control information to the circuitry and/or the first station.

2. First multi-link device as defined in embodiment 1,
wherein the first station is configured to transmit control information or preprocessed control information received by the second station and provide said control information to the first station of the second multi-link device and/or another communication device.

3. First multi-link device as defined in any one of the preceding embodiments,
wherein the control information includes one or more of:
link information indicating one or more of length of a received data unit, bandwidth of the received data unit, transmit opportunity duration, network allocation vector (NAV), received power, basic service set (BSS) identifier of the received data unit, restricted channel information of the received data unit, and state information indicating busy or idle state of the second link;
channel state information indicating an impulse response and/or transfer function between the second station and the second multi-link device and/or another communication device; and
operation advice information indicating reception of control information for configuring or reconfiguring the operation of the first multi-link device.

4. First multi-link device as defined in any one of the preceding embodiments, wherein the second station is configured to use one or more pieces of the control information for one or more of:
controlling the first station to be steered to idle links;
controlling the first station to switch to another link;
controlling itself to be steered to other links to receive control information from another communication device; and
performing a contention window (CW) countdown for the first station to transmit after the CW countdown.

5. First multi-link device as defined in any one of the preceding embodiments, wherein the first station is configured to respect a minimum observation period before it transmits after a link switch operation, and wherein the circuitry is configured to control the first station, if control information is present from a second station that obtained control information of the link to which the first station switched, to reduce or ignore the minimum observation period.

6. First multi-link device as defined in embodiment 4,
wherein the first station is configured to switch the link used for the communication with the second multi-link device and/or another communication device and to transmit a link switch announcement to the second multi-link device and/or another communication device including link switch timing indicating the time and/or duration of the link switch operation.

7. First multi-link device as defined in any one of the preceding embodiments,
wherein the second station is configured to receive enhanced multi-link single radio (EMLSR) control frames from the second multi-link device and to control the link to which the first station shall switch or focus its resources for upcoming frame exchange with the second multi-link device.

8. First multi-link device as defined in embodiment 7,
wherein an EMLSR link switch delay is different depending on whether the EMLSR control frame indicates that the link is the first link or the second link and/or wherein the EMLSR delay is signaled by the first multi-link device to the second multi-link device as part of a setup.

9. First multi-link device as defined in any one of the preceding embodiments,
wherein the first station is configured to collect configuration information from the second multi-link device and wherein the circuitry is configured to configure the second station, based on the collected configuration information, to receive control information from a link provided by the second multi-link device and not used by the first station.

10. First multi-link device as defined in any one of the preceding embodiments,
wherein the first station is configured to
advertise the existence of the second station and its parameters and capabilities to the second multi-link device and
participate in establishing or establish agreements or announce parameters with the second multi-link device on one or more of control information signaling, encryption parameters, and EMLSR switching delay.

11. First multi-link device as defined in embodiment 10,
wherein said agreements are valid for the second link to the second station of the first multi-link device and/or wherein said agreements can be the same as on the first link or can be individually set for the second link.

12. First multi-link device as defined in any one of the preceding embodiments,
wherein the second station obtains the control information from a control frame transmitted in a physical layer data unit that applies only legacy modulation and coding.

13. First multi-link device as defined in any one of the preceding embodiments,
wherein the control information received by the second station is embedded in a physical layer data unit that is split into a first part that applies legacy modulation and coding and a second part that applies advanced modulation and coding, and
wherein the second station is configured to decode and demodulate only the first part of said physical layer data unit to obtain said control information.

14. First multi-link device as defined in embodiment 13,
wherein the second station is configured to suspend reception after the first part of said physical layer data unit and continue reception once said physical layer data unit ended.

15. First multi-link device as defined in embodiment 14,
wherein the point in time of reception suspension depends to the detected format of the physical layer data unit and/or wherein the point in time of reception continuation depends on the length signaled within the first part of said physical layer data unit.

16. First multi-link device as defined in any one of the preceding embodiments,
wherein the second station is configured to support reception of physical layer data units that apply legacy modulation and coding and/or that are modulated and encoded by a modulation coding scheme of a basic rate set.

17. First multi-link device as defined in any one of the preceding embodiments,
wherein the second station is configured to support reception of physical layer data units the apply non-high throughput (non-HT) or non-HT duplicate transmission format.

18. First multi-link device as defined in any one of the preceding embodiments, comprising:
one or more first stations, each configured to communicate with one or more first stations of other multi-link devices and/or other communication devices on different links; and
one or more second stations, each configured to receive data from one or more first stations of other multi-link devices and/or other communication devices on a link that is different from a link used by one of the first stations of the first multi-link device.

19. First multi-link device as defined in any one of the preceding embodiments,
wherein the first station is configured to communicate, using a link, with a first station of the second multi-link device and/or with a station of a single link device.

20. First multi-link device as defined in any one of the preceding embodiments,
wherein the first multi-link device is configured to operate as a non-access point station (non-AP STA) or as an access point (AP).

21. First multi-link device as defined in any one of the preceding embodiments,
wherein the circuitry comprises control circuitry, media access control (MAC) layer and/or a station management entity (SME).

22. First multi-link device as defined in any one of the preceding embodiments,
wherein the second station is connected to the first station via the circuitry or directly.

23. Multi-link method of a first multi-link device comprising:
communicating, by a first station comprising a transmitter and a receiver, with a first station of a second multi-link device on a first link;
receiving, by a second station comprising a receiver but no transmitter, control information from another first station of the second multi-link device on a second link different from the first link and/or from another communication device;
controlling, by circuitry, the first and second stations; and
providing the received control information to the circuitry and/or the first station.

24. A non-transitory computer-readable recording medium that stores therein a computer program product, which, when executed by a processor, causes the method according to embodiment 23 to be performed.

25. A computer program comprising program code means for causing a computer to perform the steps of said method according to embodiment 23 when said computer program is carried out on a computer.

One or more of the following embodiments may also be combined with one or more of the embodiments disclosed above.

A1. First multi-link device comprising:
a first station comprising a transmitter and a receiver and being configured to communicate with a first station of a second multi-link device on a first link;
a second station comprising a receiver but no transmitter and being configured to receive data from another first station of the second multi-link device on a second link different from the first link; and
circuitry configured to control the first and second stations, wherein the second station is configured to provide the received data to the circuitry and/or the first station.

A2. First multi-link device as defined in embodiment A1,
wherein the first or second station is configured to collect configuration information from the second multi-link device and
wherein the circuitry is configured to configure the second station, based on the collected configuration information, to receive data from a link provided by the second multi-link device and not used by the first station.

A3. First multi-link device as defined in any one of the preceding embodiments, wherein the first station is configured to
advertise the existence of the second station and its parameters and capabilities to the second multi-link device and
participate in establishing or establish agreements with the second multi-link device on one or more of acknowledgements, encryption parameters and traffic identifiers to link mapping.

A4. First multi-link device as defined in embodiment A3,
wherein said agreements are valid for the second link to the second station of first multi-link device and/or
wherein said agreements can be same as on the first link or can be individually set for the second link.

A5. First multi-link device as defined in any one of the preceding embodiments,
wherein the second station is configured to propagate reception status information, indicating the reception status of one or more second data units received from the second multi-link device on the second link, to the first station and
wherein the first station is configured to transmit, upon receipt of the reception status information, a second acknowledgement of receipt of the one or more second data units to the second multi-link device on the first link.

A6. First multi-link device as defined in embodiment A5,
wherein the first station is configured to transmit, after it has received one or more first data units from the second multi-link device on the first link, the second acknowledgement along with a first acknowledgement of receipt of the one or more first data units or to combine the first and second acknowledgements into a single acknowledgement.

A7. First multi-link device as defined in embodiment A6,
wherein the first station is configured to advertise a reception status propagation delay to the second multi-link device, the reception status propagation delay indicating a delay of propagating the reception status information from the second station to the first station of the first multi-link device.

A8. First multi-link device as defined in any one of the preceding embodiments, comprising:
one or more first stations, each configured to communicate with one or more first stations of other multi-link devices and/or other communication devices on different links; and
one or more second stations, each configured to receive data from one or more first stations of other multi-link devices and/or other communication devices on a link that is different from a link used by one of the first stations of the first multi-link device.

A9. First multi-link device as defined in any one of the preceding embodiments,
wherein the receiver of the second station supports physical layer data units of only legacy modulation and coding format.

A10. First multi-link device as defined in any one of the preceding embodiments,
wherein the second station is configured to receive enhanced multi-link single radio (EMLSR) control frames from the second multi-link device and to control the link to which the first station shall switch or focus its resources for upcoming frame exchange with the second multi-link device.

A11. First multi-link device as defined in embodiment A3,
wherein an EMLSR link switch delay is different depending on whether the EMLSR control frame indicates that the link is the first link or the second link and/or wherein the EMLSR delay is signaled by the first multi-link device to the second multi-link device as part of a setup.

A12. First multi-link device as defined in any one of the preceding embodiments,
wherein the second station is configured to propagate reception status information indicating the reception status of one or more second data units received from the second multi-link device on the second link to the first station and
wherein the first station is configured to transmit, upon receipt of the reception status information, a second acknowledgement of receipt of the one or more second data units to the second multi-link device on the first link.

A13. First multi-link device as defined in embodiment A12,
wherein the first station is configured to transmit, after it has received one or more first data units from the second multi-link device on the first link, the second acknowledgement along with a first acknowledgement of receipt of the one or more first data units or to combine the first and second acknowledgements into a single acknowledgement.

A14. First multi-link device as defined in embodiment A13,
wherein the first station is configured to advertise a reception status propagation delay of the second multi-link device, indicating a delay of propagating the reception status information from the second station to the first station of the first multi-link device.

A15. First multi-link device as defined in any one of the preceding embodiments, comprising:
one or more first stations, each configured to communicate with one or more first stations of other multi-link devices and/or other communication devices on different links; and
one or more second stations, each configured to receive data from one or more first stations of other multi-link devices and/or other communication devices on a link that is different from a link used by one of the first stations of the first multi-link device.

A16. First multi-link device as defined in any one of the preceding embodiments,
wherein the receiver of the second station supports physical layer data units of only legacy modulation and coding format.

A17. First multi-link device as defined in any one of the preceding embodiments,
wherein the first station is configured to communicate, using a link, with a first station of the second multi-link device and/or with a station of a single link device.

A18. First multi-link device as defined in any one of the preceding embodiments,
wherein the first multi-link device is configured to operate as a non-access point station (non-AP STA) or as an access point (AP).

A19. First multi-link device as defined in any one of the preceding embodiments,
wherein the circuitry comprises control circuitry, media access control (MAC) layer and/or a station management entity (SME).

A20. First multi-link device as defined in any one of the preceding embodiments,
wherein the second station is connected to the first station via the circuitry or directly.

A21. Second multi-link device comprising:
two or more first stations, each comprising a transmitter and a receiver and each being configured to communicate with a first station or a second station of a first multi-link device, wherein one of the first stations communicates with a first station of the first multi-link device on a first link and another one of the first stations transmits to a second station of the first multi-link device on a second link, the second station of the first multi-link device comprising a receiver but no transmitter; and
circuitry configured to control the two or more first stations.

A22. Second multi-link device as defined in embodiment A21,
wherein a first station is configured, before transmitting a data unit on the second link to the second station requiring a response from the first multi-link device,
wait for reception of a response from the first station on the first link and, once the response is received, initialize its contention window value with a minimum contention value, or
initiate a further transmission and increment its contention window value.

A23. Second multi-link device as defined in any one of embodiments A21 to A22,
wherein a first station is configured to transmit low-latency data to the second station of the first multi-link device on the second link, irrespective of the state of the first link.

A24. Second multi-link device as defined in any one of embodiments A21 to A23,
wherein a first station is configured to transmit one or more data units to the second station of the first multi-link device that require no response or that require a response expected to be received via the first link.

A25. Second multi-link device as defined in any one of embodiments A21 to A24,
wherein said first station is configured to assume said one or more data units that require a response to be lost if a response was received that does not include reception status information of at least one of said one or more data units.

A26. Second multi-link device as defined in embodiment A25,
wherein said first station is configured to assume said one or more data units to be lost if a response was transmitted by the first station of the first multi-link device with a delay, after the transmission of the one or more data units ended, that is larger than a reception status propagation delay indicating a delay of propagating the reception status information from the second station to the first station of the first multi-link device.

A27. Second multi-link device as defined in any one of embodiments A21 to A26,
wherein a first station that communicates with the first station of the first multi-link device, is configured to extend its transmission by padding a last data unit transmitted to the first station of the first multi-link device or by transmitting one or more further data units to the first station of the first multi-link device.

A28. Second multi-link device as defined in embodiment A27,
wherein the first station is configured to determine the length of the extension based on a signaled reception status propagation delay indicating a delay of propagating the reception status information from the second station to the first station of the first multi-link device.

A29. First multi-link method of a first multi-link device comprising:
communicating, by a first station comprising a transmitter and a receiver, with a first station of a second multi-link device on a first link;
receiving, by a second station comprising a receiver but no transmitter, data from another first station of the second multi-link device on a second link different from the first link; and
controlling the first and second stations.

A30. Second multi-link method of a second multi-link device comprising:
communicating, by two or more first stations, each comprising a transmitter and a receiver, with a first station or a second station of a first multi-link device, wherein one of the first stations communicates with a first station of the first multi-link device on a first link and another one of the first stations transmits to a second station of the first multi-link device on a second link, the second station of the first multi-link device comprising a receiver but no transmitter; and
controlling the two or more first stations.

A31. A non-transitory computer-readable recording medium that stores therein a computer program product, which, when executed by a processor, causes the method according to embodiment A29 or A30 to be performed.

A32. A computer program comprising program code means for causing a computer to perform the steps of said method according to embodiment A29 or A30 when said computer program is carried out on a computer.

1. First multi-link device comprising:
a first station comprising a transmitter and a receiver and being configured to communicate with a first station of a second multi-link device on a first link;
a second station comprising a receiver but no transmitter and being configured to receive control information from another first station of the second multi-link device on a second link different from the first link and/or from another communication device; and
circuitry configured to control the first and second stations,
wherein the second station is configured to provide the received control information to the circuitry and/or the first station.

2. First multi-link device as claimed in claim 1,
wherein the first station is configured to transmit control information or preprocessed control information received by the second station and provide said control information to the first station of the second multi-link device and/or another communication device.

3. First multi-link device as claimed in claim 1,
wherein the control information includes one or more of:
link information indicating one or more of length of a received data unit, bandwidth of the received data unit, transmit opportunity duration, network allocation vector (NAV), received power, basic service set (BSS) identifier of the received data unit, restricted channel information of the received data unit, and state information indicating busy or idle state of the second link;
channel state information indicating an impulse response and/or transfer function between the second station and the second multi-link device and/or another communication device; and
operation advice information indicating reception of control information for configuring or reconfiguring the operation of the first multi-link device.

4. First multi-link device as claimed in claim 1,
wherein the second station is configured to use one or more pieces of the control information for one or more of:
controlling the first station to be steered to idle links;
controlling the first station to switch to another link;
controlling itself to be steered to other links to receive control information from another communication device; and
performing a contention window (CW) countdown for the first station to transmit after the CW countdown.

5. First multi-link device as claimed in claim 1,
wherein the first station is configured to respect a minimum observation period before it transmits after a link switch operation, and
wherein the circuitry is configured to control the first station, if control information is present from a second station that obtained control information of the link to which the first station switched, to reduce or ignore the minimum observation period.

6. First multi-link device as claimed in claim 4,
wherein the first station is configured to switch the link used for the communication with the second multi-link device and/or another communication device and to transmit a link switch announcement to the second multi-link device and/or another communication device including link switch timing indicating the time and/or duration of the link switch operation.

7. First multi-link device as claimed in claim 1,
wherein the second station is configured to receive enhanced multi-link single radio (EMLSR) control frames from the second multi-link device and to control the link to which the first station shall switch or focus its resources for upcoming frame exchange with the second multi-link device.

8. First multi-link device as claimed in claim 7,
wherein an EMLSR link switch delay is different depending on whether the EMLSR control frame indicates that the link is the first link or the second link and/or
wherein the EMLSR delay is signaled by the first multi-link device to the second multi-link device as part of a setup.

9. First multi-link device as claimed in claim 1,
wherein the first station is configured to collect configuration information from the second multi-link device and
wherein the circuitry is configured to configure the second station, based on the collected configuration information, to receive control information from a link provided by the second multi-link device and not used by the first station.

10. First multi-link device as claimed in claim 1,
wherein the first station is configured to
advertise the existence of the second station and its parameters and capabilities to the second multi-link device and
participate in establishing or establish agreements or announce parameters with the second multi-link device on one or more of control information signaling, encryption parameters, and EMLSR switching delay.

11. First multi-link device as claimed in claim 10,
wherein said agreements are valid for the second link to the second station of the first multi-link device and/or
wherein said agreements can be the same as on the first link or can be individually set for the second link.

12. First multi-link device as claimed in claim 1,
wherein the second station obtains the control information from a control frame transmitted in a physical layer data unit that applies only legacy modulation and coding.

13. First multi-link device as claimed in claim 1,
wherein the control information received by the second station is embedded in a physical layer data unit that is split into a first part that applies legacy modulation and coding and a second part that applies advanced modulation and coding, and
wherein the second station is configured to decode and demodulate only the first part of said physical layer data unit to obtain said control information.

14. First multi-link device as claimed in claim 13, wherein the second station is configured to suspend reception after the first part of said physical layer data unit and continue reception once said physical layer data unit ended.

15. First multi-link device as claimed in claim 14,
wherein the point in time of reception suspension depends to the detected format of the physical layer data unit and/or wherein the point in time of reception continuation depends on the length signaled within the first part of said physical layer data unit.

16. First multi-link device as claimed in claim 1,
wherein the second station is configured to support reception of physical layer data units that apply legacy modulation and coding and/or that are modulated and encoded by a modulation coding scheme of a basic rate set.

17. First multi-link device as claimed in claim 1,
wherein the second station is configured to support reception of physical layer data units the apply non-high throughput (non-HT) or non-HT duplicate transmission format.

18. First multi-link device as claimed in claim 1, comprising:
one or more first stations, each configured to communicate with one or more first stations of other multi-link devices and/or other communication devices on different links; and
one or more second stations, each configured to receive data from one or more first stations of other multi-link devices and/or other communication devices on a link that is different from a link used by one of the first stations of the first multi-link device.

19. Multi-link method of a first multi-link device comprising:
communicating, by a first station comprising a transmitter and a receiver, with a first station of a second multi-link device on a first link;
receiving, by a second station comprising a receiver but no transmitter, control information from another first station of the second multi-link device on a second link different from the first link and/or from another communication device;
controlling, by circuitry, the first and second stations; and
providing the received control information to the circuitry and/or the first station.

20. A non-transitory computer-readable recording medium that stores therein a computer program product, which, when executed by a processor, causes the method according to claim 19 to be performed.
